(19) United States
(12) Patent Application Publication
(10) Pub. No.: US 2009/0065576 A1
(43) Pub. Date: Mar. 12, 2009

(54) Card, Card Reader and Authentication System

(75) Inventors: Naoki Urushihata, Tokyo (JP); Hideki Tanemura, Tokyo (JP); Yukinobu Tajima, Tokyo (JP)

Correspondence Address: KRATZ, QUINTOS & HANSON, LLP, 1420 K Street, N.W., Suite 400, WASHINGTON, DC, 20005, US

(73) Assignee: SEEMS INC., TOKYO (JP)

(21) Appl. No.: 11/887,903

(22) PCT Filed: Jul. 15, 2005
(86) PCT No.: PCT/JP2005/013136

§ 371 Date: Apr. 22, 2008

(30) Foreign Application Priority Data
Apr. 4, 2005 (JP) 2005-107418

(51) Int. Cl. G06K 19/00; G06K 5/00

(52) U.S. Cl. 235/380; 235/487

(57) ABSTRACT

An object of the present invention is to provide a card hard to counterfeit it by reading information stored thereinside even if an electronic technique is abused, a card reader used to read such a card, and an authentication system using the card and the card reader. Therefore, in the present invention, fragrant materials (fragrant material chips 13) are placed at predetermined locations on a card surface on the side of contact with the card reader (card reader 2), and the surface on which the fragrant materials are placed in such a manner that a predetermined amount of fragrant-material molecules pass therethrough and are released, is covered so as to reach a flat surface.

### TECHNICAL FIELD

The present invention relates to an authentication system of a card, and more specifically to a system which determines whether a card is proper.

### BACKGROUND ART

It has become a common practice to use cards in various economic activities like withdrawal at a bank and payments at purchasing. Even upon automation of railroad's ticket operations, control on approach to various buildings, etc., it is common practice to use cards (including railroad commutation ticket).

In these cards, information have been stored thereinside. Such information are electronically read by a reading means (card reader or the like) to determine whether the cards are proper.

However, although an electronic information technique has been advanced, the technique of abusing an electronic information reading technique as in the case of a modus operandi called “skimming”, for example, is also growing sophisticated. If the electronic information reading technique is abused to read electronic information stored in each individual card, then the counterfeiting of each card is carried out with extreme ease. There have been found out instances which bring about substantial disadvantages to proper card users.

Various systems have recently been proposed each of which, if a card, i.e., a so-called IC card with an integrated circuit (IC chip) built therein is used with respect to such a modus operandi like skimming that information stored in each card is improperly read, provides a high security level, using such an IC card (refer to, for example, a patent document 1).

However, the rate of progress in the electronic information technique is extremely fast, and a reading method which breaks down a security level at once even if the security level is improved, has been developed. The fact is that a so-called “rat race” has been repeated.

In other words, even though an electronic technique is used to prevent the technique of improperly reading information, like skimming and others, criminals will develop a new technique for invalidating the corresponding preventing technique.

Patent document 1: Japanese Patent Laid-Open No. 2004-78326

### DISCLOSURE OF THE INVENTION

### Problems that the Invention is to Solve

The present invention has been proposed in view of the problems of the foregoing prior art. It is an object of the present invention to provide a card hard to counterfeit it by reading information stored thereinside even though an electronic technique is abused, a card reader used to read such a card, and an authentication system using the card and the card reader.

### Means for Solving the Problems

A card (1) of the present invention is characterized in that fragrant materials (fragrant material chips 13) are placed at predetermined locations in a surface thereof on the side of contact with a card reader (card reader 2), and the surface thereof on which the fragrant materials are placed in such a manner that a predetermined amount of fragrant-material molecules pass therethrough and are released, is covered so as to reach a flat surface (refer to claim 1).

Now, a surface layer portion or a film (14) is used upon covering the fragrant materials. The surface layer portion or film (14) may preferably be configured so as to allow fragrant-material molecules to be released from the fragrant material chips (13). Described more specifically, the surface layer portion or film (14) is capable of releasing the fragrant-material molecules to such an extent as to be detectable by sensors (S1 through S4) on the card reader (2) side to be described later. However, the amount of their release may preferably be set to such an extent that the fragrant-material molecules released from the fragrant materials are not eliminated in a short period of time.

The card reader (card reader 2) of the present invention, for reading information stored in the card (card 1 according to claim 1) comprises sensors (S1 through S4) provided at positions corresponding to the fragrant materials (fragrant material chips 13) placed on the card (1), wherein the sensors (e.g., thin-film sensors or enzyme sensors or the like S1 through S4) are configured so as to output detect signals, responsive to only one type of fragrant material (refer to claim 3).

An authentication system of the present invention having the above card (card 1 according to claim 1) and the card reader (card reader 2 according to claim 3) comprises: a card (1) in which fragrant materials (fragrant material chips 13) are placed at predetermined locations on a surface thereof, and the surface thereof on which the fragrant materials are placed in such a manner that a predetermined amount of fragrant-material molecules pass therethrough and are released, is covered so as to become a flat surface; a card reader (2) for reading the card (1), which is configured in such a manner that sensors (S1 through S4) are provided at positions corresponding to the fragrant materials (fragrant material chips 13) placed in the card (1) and output detect signals, responsive to only one type of fragrant material; and control means (control unit 7) which determines whether the card (1) brought into contact with the card reader (2) is a proper card, in response to the detect signals sent from the sensors (S1 through S4) of the card reader (2) (refer to claim 5).

Information readable by electronic reading means (2M) may preferably be stored in the card (1A) of the present invention (refer to claim 2).

Here, the information readable by the electronic reading means (2M) contains magnetically read information.

The card reader (2A) of the present invention may preferably be equipped with electronic reading means (2M) configured so as to electronically read the information stored in the card other than the fragrant materials (refer to claim 4).

An authentication system of the present invention, having the above card (card 1 according to claim 2) and card reader (card reader 2A according to claim 4) comprises a card (1A) in which fragrant materials (fragrant material chips 13) are placed at predetermined locations in a surface thereof, and the surface thereof on which the fragrant materials are placed in such a manner that a predetermined amount of fragrant-material molecules pass therethrough and are released, is covered so as to become a flat surface, and in which information readable by electronic reading means (2M) is being stored; a card reader (2A) for reading the card (1A), which is configured in such a manner that sensors (Sa through Sc) are provided at positions corresponding to the fragrant materials (fragrant material chips 13) placed in the card and output detect signals, responsive to only one type of fragrant material, and which is equipped with electronic reading means (2M) configured so as to electronically read the information stored in the card other than the fragrant materials; and control means (control unit 7) which determines whether the card (1A) brought into contact with the card reader (2A) is a proper card, in response to the detect signals sent from the sensors (Sa through Sc) of the card reader (2A) and a read signal sent from the electronic reading means (2M) (refer to claim 6).

Upon implementation of the present invention, in order to properly hold relative positions among the fragrant materials for the card and the sensors of the card reader and allow the fragrant-material molecules released from the fragrant material chips (13) to be reliably detected by their corresponding sensors (Sa through Sc) if the card is of a proper card (refer to FIG. 15), it is preferable that the card reader (2B) is provided with a card mounting guide (2Ba) and the installation position of the card is provided so as to be fixed to a predetermined position by the guide (2Ba) (refer to FIG. 14).

In the present invention, heating means (e.g., electric heaters H) may preferably be provided around the sensors of the card reader (card reader 2) side to improve detection capability of each sensor by increasing the temperature thereof (refer to FIG. 17).

In addition to above, the present invention is provided with a mechanism (vacuum pipe arrangements Lv1 through Lv6 and Lv, and vacuum blower 50) for generating negative pressure on the card reader (2D) side. The card (1) is configured so as to be sucked by the card reader (2D) and adhered thereto. Thus, preferably, the fragrant-material molecules released from the fragrant material chips (13) provided in the card (1) are reliably detected by the nearby sensors (Sa through Sc) and undetected by the adjacent sensors (refer to FIG. 18).

### EFFECTS OF THE INVENTION

According to the present invention equipped with the above configuration, if fragrant materials to which the sensors (S1 through S4) of the card reader (2) are sensitive, are selected as the fragrant materials placed in the proper card (1), then the sensors (S1 through S4) detect fragrant-material molecules released therefrom and thereby output detect signals. As a result, the card (1) with the fragrant materials placed therein can be judged as a proper card.

Of course, dummy fragrant materials can also be provided (refer to FIGS. 6 and 7).

Here, a so-called “dry-system” technique such as an electronic information technique or the like is not able to analyze a “wet system” like fragrant materials. And the existing electronic technique is not capable of falsifying and counterfeiting information about fragrance. Thus, no matter how the electronic information technique becomes advanced, it is difficult to analyze the fragrance coated over the card of the present invention. It is still more absolutely impossible to blend or make up such fragrant materials and counterfeit the card.

That is, according to the present invention, a card that makes it impossible to counterfeit it with other modus operandi like “skimming” that has abused the electronic information reading technique, can be provided. As a matter of course, the modus operandi such as skimming cannot fudge the card reader and authentication system of the present invention.

In the present invention, the information readable by the electronic reading means (2M) has been stored in the card (1A) (1Aa) (refer to claim 2). The card reader (2A) is equipped with the reading means (2M) for electronically reading the information (other than the fragrant materials) (1Aa) stored in the card (1A) (refer to claim 4). The authentication system is configured in such a way as to determine whether the card (1A) brought into contact with the card reader (2A) is a proper card, in response to the detect signals (from the card reader) indicative of whether the sensors are sensitive to the fragrant-material molecules and the read signal sent from the electronic reading means (2M) (refer to claim 6). If done in this way, then such a configuration can cope with the technique of abusing the electronic information reading technique like “skimming” and the like because the fragrance is used for authentication in a manner similar to the above. Besides, even if the “fragrance” can be analyzed and specified using the so-called “wet-system” technique, such a “wet-system” technical facility is not capable of reading the existing electronic information.

In other words, if the fragrance information and the existing electronic information reading technique are utilized in combination, the card cannot be counterfeited unless the facility for analyzing the fragrance and the existing electronic information reading technical facility are prepared simultaneously. Besides, since the electronic information reading technique that belongs to the so-called “dry-system” technique, and the technique about the fragrance that belongs to the so-called “wet-system” technique are much different in technical field from each other, it is difficult to provide both facilities together.

That is, according to the present invention (claims 2, 4 and 6) which utilizes the fragrance information and the existing electronic information reading technique in combination, it is possible to provide a card that makes it more difficult to counterfeit it (1A), and a system using the same.

### BEST MODE FOR CARRYING OUT THE INVENTION

Preferred embodiments of the present invention will hereinafter be described with reference to the accompanying drawings.

A first embodiment of the present invention will first be described with reference to FIGS. 1 through 9.

FIG. 1 shows a gate opening/closing mechanism that makes use of an authentication system using a card according to the first embodiment.

In FIG. 1, the gate opening/closing mechanism comprises a card reader 2 which reads information of the card 1 according to the first embodiment, a gate 3 opened/closed by allowing a person P having the card 1 to operate the card reader 2 through the card 1, an actuator 4 which operates or controls the opening/closing of the gate 3, a pressure fluid source (e.g., air tank) 5 which supplies fluid pressure (e.g., compressed air) to the actuator 4, fluid supply lines La1 and La2, a fluid discharge line Lx, a three-way valve 6 interposed in a point of intersection of the fluid supply lines La1 and La2 and the fluid discharge line Lx, and a control unit 7 which controls the opening/closing of the three-way valve 6 based on the information read by the card reader 2.

The card reader 2 is provided with sensors S1 through S4. The sensors S1 through S4 react with only a specific single fragrant material and are configured so as to output detect signals.

As such types of sensors, for example, a so-called “thin-film” type sensor, and a sensor of a type using enzyme can be utilized. Since the “thin-film” type sensor is capable of detecting up to the concentration of “a ppb” level in particular, it can reliably detect a molecule of a released fragrant material and output a detect signal as will be described later.

As shown in the form of a cross section in FIG. 1, the card 1 is formed, on a substrate 11, with concave portions 12 for burring or embedding fragrant material chips 13 therein as viewed on the side of contact of the surface of the card 1 with the card reader 2. The fragrant material chips 13 are embedded in their corresponding concave portions 12. With the fragrant material chips 13 embedded therein, the side of the card that contacts the card reader 2 is covered with a surface layer portion or a film 14 over its entirety. The surface layer portion or film 14, which covers the fragrant material chips 13, is formed with micropores 15 of such a degree as to allow the release of the molecule of each fragrant material.

It is now desirable that the micropores 15 are large to such an extent as to eliminate or release fragrant-material molecules equal to a number of such an extent that the sensors S1 through S4 can detect the molecules of the fragment materials, and are small to such an extent that the fragrant-material molecules released from the fragrant material chips 13 are not removed in a short period.

In other words, when the micropores 15 are excessively small, the fragrant-material molecules released from the fragrant material chips 13 cannot be detected by the sensors S1 through S4. When the micropores 15 are excessively large, the fragrant-material molecules are not released from the fragrant material chips 13 at an early time, thereby causing inconvenience that the service life of the card 1 used as identifying means is shortened.

As the fragrant material selected as the fragrant material chip 13, may be mentioned various ones. Ones hard to be detected with the human sense of smell are suitable in terms of counterfeit prevention.

The amount of release of the fragrant-material molecules may preferably be suppressed in such a manner that upon embedding the fragrant material chips 13 into the substrate 11 of the card 1, the period to release the fragrant-material molecules becomes a long period to a sufficient extent as a period of service for the card 1.

Referring back to FIG. 1, the card reader 2 is provided with a contact sensor (hereinafter called “card detection sensor”) 21 which detects that the card 1 per se has contacted the card reader 2.

It is assumed that when a forged card has contacted the card reader 2, the fragrant material chips are not embedded in the card 1. This is because since the sensors S1 through S4 do not generate detect signals in such a case when the contact sensor 21 is not provided which detects the contact of the card 1 itself with the card reader 2, the control unit 7 is not capable of determining the card 1 as being placed in a state of being not in contact with the card reader 2.

When the card 1 contacts the card reader 2 here, it is necessary that the position of each fragrant material chip 13 coincides with the position of each of the sensors S1 through S4 on the card reader 2 side. In other words, fragrant-material particles released from the fragrant material chips 13 need to have accuracy equivalent to such a degree that they are reliably detected by the corresponding sensors S1 through S4.

Incidentally, although the opening/closing of the gate 3 is performed using fluid pressure by an opening/closing operation of the three-way valve 6 having received an opening/closing control signal from the control unit 7 in FIG. 1, another system may be used.

The opening/closing of the gate 3 may be carried out using, for example, mechanical means other than the fluid pressure, or a magnetic force. In such a case, the control signal outputted from the control unit 7 results in a control signal of the mechanical means or magnetic force means in place of a valve's opening/closing signal.

As described above in FIG. 1, the plurality of concave portions 12 are formed in the surface of the substrate 11 on the side of contact of the card 1 with card reader 2, and the fragrant material chips 13 are inserted into their corresponding concave portions 12 and covered with the film 14 from thereabove. As shown in FIG. 2, however, the fragrant material chips 13 are placed on the surface thereof on the side of contact of the card 1 with the card reader 2, and they may be covered with the covering layer or film 14 in this state. Such a technique as shown in FIG. 2 is suitable from the viewpoint that manufacturing processes are reduced to lower manufacturing costs.

In this case, the forms of the fragrant material chips 13 may preferably be configured as forms hard to move upon placement of the fragrant material chips 13 on the card substrate 11 in order to prevent the positions of the fragrant material chips 13 from being shifted from the positions of the sensors S1 through S4 on the card reader 2 side after the fragrant material chips 13 are placed on the substrate 11 of the card 1 and covered.

In FIG. 1, symbol Li indicates a signal line for connecting the card detection sensor 21 and the control unit 7, and symbol Lis indicates a signal line for connecting the respective fragrant sensors and the control unit 7, respectively.

FIG. 3 is a block diagram showing in detail the control unit 7 shown in FIG. 1. A detailed configuration of the control unit 7 will be explained below with reference to FIG. 3.

The control unit 7 includes an interface 71 which receives information from the card detection sensor 21 of the card reader 2 through the line Li, and sensor-specific interfaces 721 through 724 which correspond to the sensors S1 through S4 of the card reader 2 and receive information from the sensors S1 through S4 of the card reader 2, respectively.

Also the control unit 7 has comparing means 731 through 734 which respectively receive the information received by the sensor-specific interfaces 721 through 724 via lines L11 through L14 and compare the information with threshold values, and an authentication determining means 74 which receives the results of comparisons from the comparing means 731 through 734 via lines L21 through L24 and comprehensively judges those information to make a decision as to authentication.

Further, the control unit 7 includes a data base 75 which stores the threshold values therein, and a three-way valve opening/closing control signal generating means 76 which receives the result of decision by the authentication determining means 74 via a line L4 and generates an opening/closing control signal to the three-way valve 6, based on the result of decision.

The data base 75 is connected to the respective comparing means 731 through 734 by lines L30, L31 through L30 and L34 and offers threshold values (for example, a predetermined amount of a fragrant material 12 corresponding to the sensor S1, which is detected in unit time) to the comparing means 731 through 734. Also the data base 75 is connected even to the authentication determining means 74 via a line L35 and supplies decision reference values (for example, values at which detected amounts from all the sensors satisfy threshold values for all the sensors) to the authentication determining means 74.

Upon determination done by the authentication determining means 74, the card is determined to be a suitable card only when all the sensors S1 through S4 detect their corresponding fragrant-material molecules and output their detect signals as indicated by the decision criterion of FIG. 4 and the decision method of FIG. 6.

That is, according to the decision criterion shown in FIG. 4, the sensors on the card reader 2 side, corresponding to a chip C1 for fragrance A, a chip C2 for fragrance B, a chip C3 for fragrance C and a chip C4 for fragrance D on the card 1 side, are equivalent to the sensor S1 which detects only the fragrance A, the sensor S2 which detects only the fragrance B, the sensor S3 which detects only the fragrance C, and the sensor S4 which detects only the fragrance D. The card is authenticated only when all the results of detections by the sensors are detected a predetermined amount (threshold value) or more (the detected results are all ◯).

A decision control method at the decision criterion of FIG. 4 will be explained based on FIG. 5.

In Step S1, the control unit 7 first monitors whether a signal for the card 1 detected by the card detection sensor 21 exists. When the card detection is made (the answer is YES in Step S1), the control unit 7 proceeds to Step S2 where it reads signals from the sensors S1 through S4 and reads the corresponding threshold values from the data base 75.

In Step S3, the comparing means 731 through 734 of the control unit 7 determine whether the values of detect signals detected by all the sensors S1 through S4 are greater than or equal to the threshold values. When the values of the detect signals detected by the all the sensors S1 through S4 are greater than or equal to the threshold values (the answer is YES in Step S3), the control unit 7 proceeds to Step S4. On the other hand, when the output sensors exist in which their values are less than the threshold values (the answer is NO in Step S3), the control unit 7 proceeds to Step S5.

The control unit 7 determines the card as a suitable card in Step S4. Although not shown in the drawing, the control unit 7 terminates control after it has transmitted a control signal to the three-way valve 6 so as to open the gate 3′.

On the other hand, the control unit 7 judges the card being in operation as being improper in Step S5. Then, the control unit 7 terminates control after it has transmitted a control signal to the three-way valve 6 so as to close the gate 3.

Now, another determining method may be constituted in such a manner that the card is determined as a “suitable card” only where, for example, only specific sensors do not output detect signals and other sensors outputs detect signals.

Such control is indicated by the decision criterion of FIG. 6 and a control flowchart shown in FIG. 7.

That is, only the chip C3 is embedded as a fragrance-free chip, a so-called dummy chip on the sensor side of the card 1 in the case of the decision criterion shown in FIG. 6 as compared with the decision criterion shown in FIG. 4. The decision criterion is constituted so as to be authenticated only where the results of S1 through S4 are combinations of ◯◯X◯ as shown in the column of a detected result in Table of FIG. 6.

A decision control method at the decision criterion shown in FIG. 6 will be explained based on FIG. 7.

In Step S11, the control unit 7 first monitors whether a signal for the card 1 detected by the card detection sensor 21 exists. When the card detection is made (the answer is YES in Step S11), the control unit 7 proceeds to Step S12 where it reads signals from the sensors S1 through S4 and reads their corresponding threshold values from the data base 75.

In Step S13, the comparing means 731 through 734 of the control unit compare the detect signals of the sensors S1 through S4 and the respective threshold values, and determine combinations (OOXO in the example of FIG. 6) of the respective sensors S1 through S4 and ◯ and X each indicative of the detected result, where the detected results are expressed as ◯ when the respective detect signals are respectively greater than or equal to the threshold values and where the detected result is expressed as X when each detect signal is less than the threshold value.

In next Step S14, the control unit 7 determines whether the combination (e.g., ◯◯X◯) of Step S13 referred to above is registered in the card 1. If it is found to be registered therein (the answer is YES in Step S14), then the control unit 7 proceeds to Step S15. If it is found not to be registered therein (the answer is NO in Step S14), then the control unit 7 proceeds to Step S16.

The control unit 7 determines the card as a suitable card in Step S15. Although not shown in the drawing, the control unit 7 terminates control after it has transmitted a control signal to the three-way valve 6 so as to open the gate 3.

On the other hand, the control unit 7 judges the card being in operation to be improper in Step S16. Then, the control unit 7 terminates control after it has transmitted a control signal to the three-way valve 6 so as to hold the gate 3 closed.

According to the decision method of FIG. 6 and the control shown in the flowchart of FIG. 7, when, for example, a card counterfeiter becomes aware that a fragrant material or fragrance contributes to an authenticity decision, the card reader 2 provides the effect of mixing dummy's' fragrant material chips (fragrant materials always insensitive to the sensors) to thereby make card counterfeiting hard.

That is, the sensor S3 that reacts with the fragrant material chip C3 under the decision method of FIG. 6 and the control flowchart of FIG. 7 is mounted to the card reader 2 assuming that when a given card becomes lost, a counterfeiter uses the lost card. Consequently, when the card which is formed by forging the lost card 1 by counterfeiter is in contact with the card reader 2, the sensor S3 outputs a detect signal (it results in “◯” in FIG. 6), and hence the authentication determining means determines the card as an “improper card”.

FIG. 8 is a plan view showing the details of a layout example of an area which is located around the gate 3 shown in FIG. 1 and in which a gate opening/closing mechanism 300 and a card authentication processing mechanism 200 are disposed.

In FIG. 8, the card authentication processing mechanism 200 includes, in the example illustrated in the figure, a card insertion slot 212 defined in an inlet portion 211 of a counter 210 whose one side extends along a passage C of a wall surface W, and the card detection sensor 21 placed in the neighborhood of the card insertion slot 212. The card detection sensor 21 acts as a switch for activating a card conveying means 213 to be described later.

A card conveying means (e.g., a card conveying path along which an unillustrated belt conveyer is activated in an internal direction from the card insertion slot) 213 having a predetermined length as viewed from the card insertion slot 212 is built into the counter 210. The card reader 2 is placed in the deepest portion of the conveying path 213.

A card stopper 8 for stopping the card 1 at a predetermined position of the card reader 2 is provided ahead of the card reader 2. The card stopper 8 is operated so as to expand and shrink by an actuator (e.g., air cylinder) 9 for the card stopper. The card stopper 8 is provided to make a relative position between the inserted card 1 and the card reader 2 appropriate. This is because there exists a risk that when the position of the card 1 relative to the card reader 2 is not proper even in the case of the suitable card 1 as will be described later in association with FIGS. 15 and 16, the sensors S1 through S4 provided in the card reader 2 detect molecules of fragrant material chips other than their corresponding fragrant material chips 13 and hence the control unit 7 determines the card as being an “improper card”.

A card takeout slot 215 is provided in the rear (below as viewed in the drawing) of the card stopper 8 and at a rear end 214 of the counter 210. A card ejection sensor 22 for detecting that the card has been taken out is provided in the neighborhood of the card takeout slot 215. The card ejection sensor 22 acts as a stop switch for the card conveying means 213.

As described above, compressed air is supplied from the air tank 5 to the gate opening/closing actuator 4 via the air supply lines La1 and La2, and the three-way valve 6 is interposed in a connecting portion of the air supply lines La1 and La2.

Compressed air is supplied from the air tank 5 to the actuator 9 for the card stopper via its corresponding lines La1, La3 and La4, and a three-way valve 60 different from the above is interposed in a connecting portion of the air supply lines La3 and La4.

The three-way valve 6 for the gate control and the three-way valve 60 for the card stopper are respectively connected to the control unit 7 by their corresponding control signal lines Loa and Lob.

The card conveying means 213 is connected to the control unit 7 via a control signal line L213. The card detection sensor 21 and the card ejection sensor 22 are respectively connected to the control unit 7 via signal lines L21 and L22. In FIG. 8, symbol Lis indicates a signal line for connecting the card reader 2 and the control unit 7 in the above-described manner.

Card processing that accompanies card authentication (inclusive of card non-authentication), and control for opening/closing of the gate 3 will be explained below based on FIG. 9.

First, the card detection sensor 21 waits till the card is detected (Step S21). When the card is detected (the answer is YES in Step S21), the control unit 7 proceeds to Step S22, where it activates the card conveying means 213.

In the following Step S23, the control unit 7 expands the actuator 9 for the card stopper to stop the card conveying means 213. In doing so, the thrown-in card 1 stops at a predetermined position of the card reader 2 and the control unit 7 performs determination using the sensors S1 through S4 (Step S24).

In next Step S25, the control unit 7 monitors whether the determination is terminated. When the determination is completed (the answer is YES in Step S25), the control unit 7 proceeds to the next Step S26. If the determination is not completed (the answer is NO in Step S25), then the control unit 7 repeats Steps subsequent to Step S24 again.

In Step S26, the control unit 7 determines whether the card is proper. If the card is found to be proper (the answer is YES in Step S26), then the control unit 7 proceeds to Step S27. If the card is found not to be proper (the answer is NO in Step S26), then the control unit 7 proceeds to Step S30.

In Step S27, the gate opening/closing actuator 4 is activated to open the gate 3. Although not described in the flowchart, the control unit 7 next detects the passage of a card holder through the gate 3 by means of, for example, an unillustrated infrared sensor and operates the card conveying means 213 in a forward direction again, and takes out the card 1 from the card takeout slot 214 (Step S28). In Step S29, the control unit 7 detects card ejection through the card ejection sensor 22 and thereafter stops the card conveying means 213 to terminate the control.

In Step S30, the control unit 7 reverses the card conveying means 213 to back up the card 1, and ejects the card 1 from the insertion slot 212. In the following Step S31, the control unit 7 detects the extraction of the card from the insertion slot 212 by use of the card detection sensor 21 and thereafter stops the reversal of the card conveying means 213 to complete the control.

While the technique of reading electronic information is now being so advanced, the technique of abusing the electronic information reading technique as in the case of a modus operandi called “skimming”, for example, is also developed.

In the first embodiment shown in FIGS. 1 through 9, however, the counterfeit card cannot be judged to be a proper card unless the fragrance is counterfeited. As is well known, it is not possible to falsify and counterfeit information about the fragrance in the existing electronic technology.

That is, according to the first embodiment of the present invention, it is possible to provide a card which makes it impossible to counterfeit it using “skimming” and other modus operandi that abuse the electronic information reading technique.

A second embodiment of the present invention will next be explained with reference to FIGS. 10 through 13.

The fragrant material chips are embedded into the card 1 used in the first embodiment shown in FIGS. 1 through 9. The card reader 2 or the authentication system determines whether the card 1 is proper, depending on only whether the fragrance is appropriate.

In contrast, the second embodiment shown in FIGS. 10 through 13 combines the existing electronic authentication (including authentication based on magnetically measured information) and authentication based on fragrance.

In FIGS. 10 and 11, a card 1A employed in the second embodiment has a portion 1Aa in which information that makes an electronic decision possible as in the existing various cards is expressed (or stored), and a portion 1Ab in which fragrance information is stored.

That is, as to the “portion in which the information that makes the electronic decision possible is stored” 1Aa, the known system is so far applied thereto as it is, and the portion 1Aa is configured in such a manner that electronic information can be stored and read.

On the other hand, as to the “portion in which the fragrance information is being stored” 1Ab, fragrant material chips 13 are embedded into the portion in a manner similar to the first embodiment shown in FIGS. 1 through 9. As to the form of embedding of the fragrant material chips 13, as shown in FIG. 11, the fragrant material chips 13 may be covered with a coating or covering layer or a film 14 in a state in which they are placed on a card substrate 11. Alternatively, concave portions are defined in the card substrate and the fragrant material chips 13 may be disposed within the concave portions and covered therewith.

FIG. 12 shows, as a block diagram, an authentication system using such a card 1A as shown in FIGS. 10 and 11. A configuration of the authentication system will be explained below based on FIG. 12.

In FIG. 12, the authentication system according to the second embodiment has a reading means 2A comprising a card reader 2M used as an electronic information reading means, and a fragrance detection section 2S using fragrant material sensors Sa through Sc, a control unit 7A, and a monitor 77 corresponding to a display means.

The control unit 7A comprises an interface 72A which takes information from the fragrant material sensors Sa through Sc, a fragrance information decoding means 78 which decodes the type of fragrance and the amount thereof in accordance with the information sent from the interface 72A, an interface 72B which takes information from the card reader 2M, an electronic information analyzing means 79 which analyzes electronic information in accordance with the information sent from the interface 72B, a determining means 73A and a data base 75A. Here, the known/commercially-available member can be diverted to the electronic information analyzing means 79 as it is.

Authentication determining control of the second embodiment will next be explained based on FIG. 13.

First, in Step S41, the control unit 7A reads electronic information through the card reader 2M and reads fragrance information through the fragrance detection section 2S, and proceeds to Step S42.

In Step S42, the control unit 7A waits until the reading is completed. When the reading is completed (the answer is YES in Step S42), the control unit 7A compares normal electronic information and normal fragrance information taken out from the data base 75A (Step S43).

In the following Step S44, the determining means 73A of the control unit 7A makes a decision as to whether the electronic information and the fragrance information are both proper. If they are found to be proper (the answer is YES in Step S44), then the control unit 7A determines the card as a proper card (Step S45) and terminates the control. On the other hand, if they are found not to be proper (the answer is NO in Step S44), then the control unit 7A determines the card as an improper card and terminates the control.

Only when the electronic information read by the card reader 2M corresponding to the electronic information reading means and the signal about the fragrance detected by the fragrance detection section 2S corresponding to the fragrance information reading means are both proper in FIGS. 12 and 13, “the card is judged as proper”. However, the control unit may first determine whether the electronic information is proper and then determine whether the information about the fragrance is proper. Alternatively, in reverse, the control unit may first determine whether the information about the fragrance is proper and then determine whether the electronic information is proper.

Although not definitely illustrated in the drawing, the electronic information and the information about the fragrance are simultaneously read by the reading means and their suitability is determined simultaneously, and “the card may be judged as proper” when both are proper.

Since the second embodiment shown in FIGS. 10 through 13 also makes use of fragrance for authentication in a manner similar to the first embodiment referred to above, the present embodiment is capable of coping with “skimming” and other technique of abusing an electronic information reading technique.

In the second embodiment in particular, a facility for specifying the fragrance is not able to read the existing electronic information even if the fragrance could be specified.

In other words, card's counterfeiting is impossible in the second embodiment shown in FIGS. 10 through 13 unless the existing electronic information reading technique and the facility for analyzing the fragrance are prepared simultaneously. Since, however, the electronic information reading technique and the technique for analyzing the fragrance are much different in technical field from each other, it is difficult to provide both facilities together.

That is, according to the second embodiment of the present invention, it is possible to provide a card that makes it more difficult to counterfeit it, and a system using the same.

A third embodiment of the present invention will next be explained with reference to FIGS. 14 through 16.

When the position of a card relative to sensors of a card reader is shifted, the positions of fragrant material chips 13 relative to the sensors Sa through Sc are also shifted as shown in FIG. 16 even if a proper card is used. As a result, ones closest to the sensors Sa through Sc result in the different fragrant material chips even if the proper card is used. Thus, the respective sensors Sa through Sc do not generate detect signals and perform misjudgment of the card as an “improper card”.

In contrast, if a card mounting guide 2Ba is provided in a card reader 2B as shown in FIG. 14, then the installation position of a card 1 is fixed to a predetermined position, i.e., positions corresponding to the sensors Sa through Sc of the card reader 2B by means of the card mounting guide 2Ba as shown in FIG. 15. Therefore, the relative positions among the fragrant material chips 13 and the sensors Sa through Sc are always held proper. If the proper card is used, then fragrant-material molecules released from the fragrant material chips 13 are reliably detected by their corresponding sensors.

That is, the card mounting guide 2Ba is a so-called bank-shaped edge that surrounds the area in which the card is placeable reasonably.

Providing the card mounting guide 2Ba of such a structure prevents the occurrence of such a misjudgment as in the case shown in FIG. 16.

Other constitutions and operation/effects of the third embodiment are similar to the first embodiment shown in FIGS. 1 through 9 and the second embodiment.

A fourth embodiment of the present invention will next be explained with reference to FIG. 17.

It is known that the sensitive performance of each sensor tends to improve as a sensor temperature increases.

In the fourth embodiment shown in FIG. 17, the detection capability of each sensor is improved using such a property. That is, heating means (e.g., electric heaters) H are provided around their corresponding sensors Sa through Sc provided on the card reader 2C side upon determining whether a card is proper. These heaters H are connected in series with a power supply E through a power supply line Le. A current is fed from the power supply E to thereby allow the heating means H to increase sensor temperatures, whereby the detection capability of each sensor is enhanced.

Other constitutions and operation/effects of the fourth embodiment are similar to the first through third embodiments.

A fifth embodiment of the present invention will next be described with reference to FIG. 18.

In the above-described respective embodiments, it is necessary that fragrant-material molecules released from fragrant material chips provided in a card are reliably detected by nearby sensors and not detected by adjacent sensors in order to accurately determine whether the card is proper.

Therefore, the fifth embodiment shown in FIG. 18 is provided with a mechanism for generating negative pressure on the card reader 2D side. The mechanism is configured in such a manner that the card is sucked by the card reader and adhered thereto.

In FIG. 18, a card mounting guide 2Da similar to the second embodiment (see FIG. 14) is provided on the surface side of the card reader 2D on which the card 1 is placed.

Suction holes 2Db (six in total in the example illustrated in drawing) are formed in a surface 2Df which is surrounded by the guide 2Da and on which the card is placed, and in pairs at positions where fragrant material chips 13 of the card 1 are respectively interposed therebetween.

The respective suction holes are connected to a vacuum pump or a vacuum blower 50 by means of a vacuum line Lv at which vacuum lines Lv1 through Lv6 and vacuum lines Lv1 through Lv6 are merged with one another.

In the fifth embodiment configured in this way, the vacuum blower 50 is activated to force the card 1 to suck into the card mounting surface 2Df of the card reader 2D. Accordingly, the fragrant-material molecules released from the fragrant material chips provided in the card are reliably detected by the nearby sensors and undetected by the adjacent sensors.

Other constitutions and operation/effects of the fifth embodiment are similar to the first through fourth embodiments.

The illustrated embodiments are illustrations only and not intended for description of the substance that limits the technical scope of the present invention.

Although the three to four fragrant material chips are placed on the surface of the card in the illustrated embodiment, for example, the number of fragrant material chips to be placed is not limited to it. A single fragrant material chip may be used or two or five fragrant material chips may be used.

### BRIEF DESCRIPTION OF THE DRAWINGS

FIG. 1 is a typical view showing a configuration of an overall authentication system according to a first embodiment of the present invention.

FIG. 2 is a sectional view illustrating a configuration of a card for the authentication system according to the first embodiment.

FIG. 3 is a block diagram showing a configuration of control means according to the first embodiment.

FIG. 4 is a view showing a table that provides a summary of a first decision criterion according to the first embodiment.

FIG. 5 is a flowchart depicting decision control based on the first decision criterion according to the first embodiment.

FIG. 6 is a view showing a table that provides a summary of a second decision criterion according to the first embodiment.

FIG. 7 is a flowchart illustrating decision control based on the second decision criterion according to the first embodiment.

FIG. 8 is a plan view showing in detail a layout example of an area which is located around a gate employed in the first embodiment and in which a gate opening/closing mechanism and a card authentication processing mechanism are disposed.

FIG. 9 is a flowchart for describing a method for performing card processing control and guide opening/closing control, according to the first embodiment.

FIG. 10 is a perspective view of a card according to a second embodiment of the present invention.

FIG. 11 is a sectional view of the card according to the second embodiment.

FIG. 12 is a block diagram for describing a configuration of a control system according to the second embodiment.

FIG. 13 is a flowchart for describing a control method according to the second embodiment.

FIG. 14 is a perspective view of a card reader according to a third embodiment of the present invention.

FIG. 15 is an explanatory view showing a method for using a card according to the third embodiment.

FIG. 16 is a mode view illustrating a state in which a card is placed in an improper position where the card is placed in its corresponding card reader.

FIG. 17 is a sectional view of a card reader according to a fourth embodiment of the present invention.

FIG. 18 is a mode view showing a state in which a card is placed in a card reader according to a fifth embodiment of the present invention.

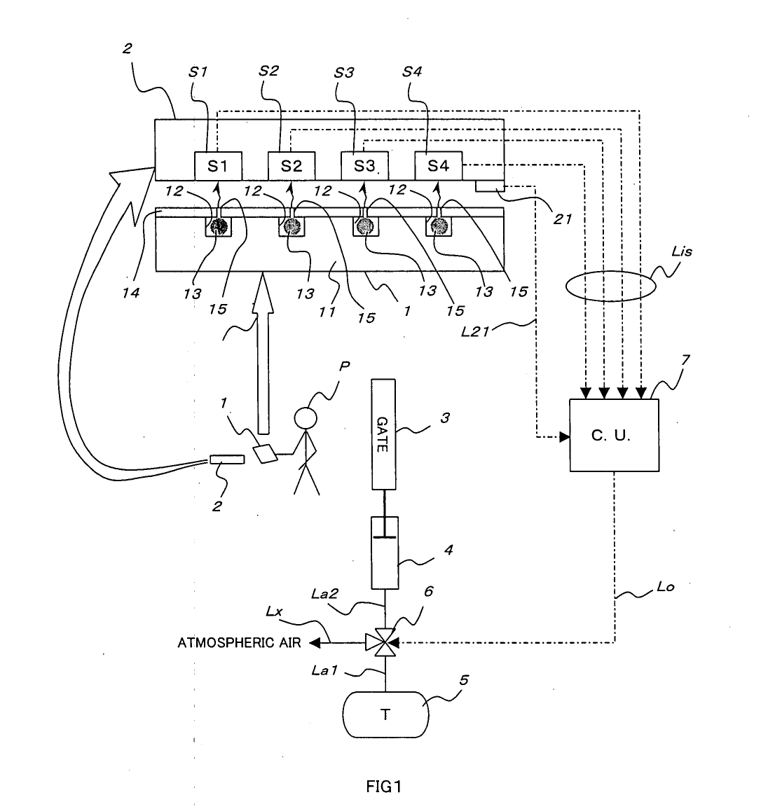

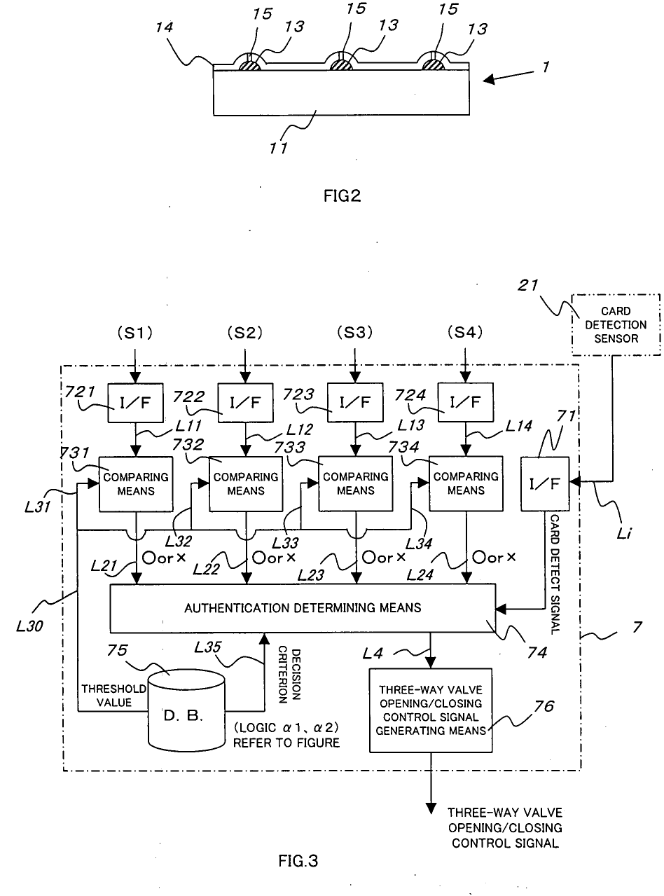

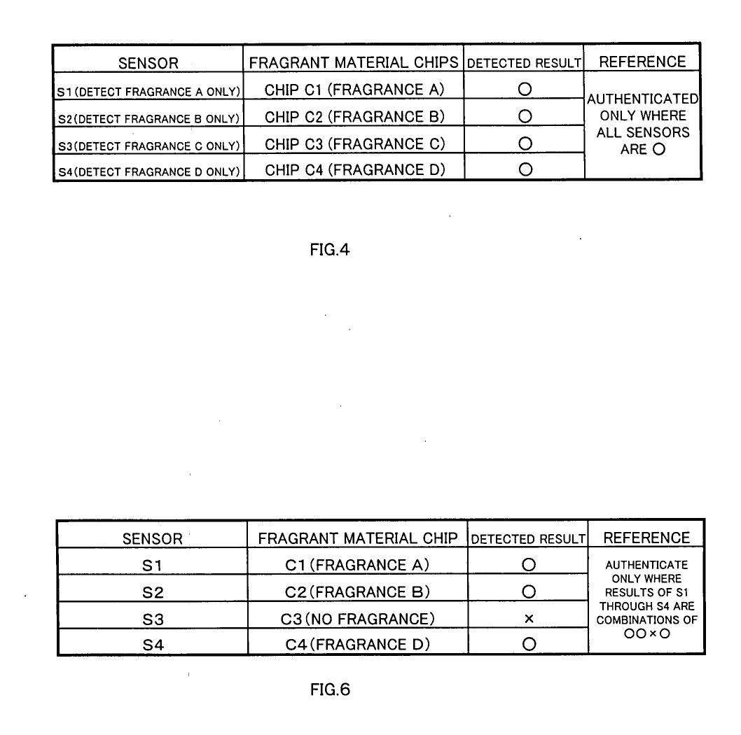

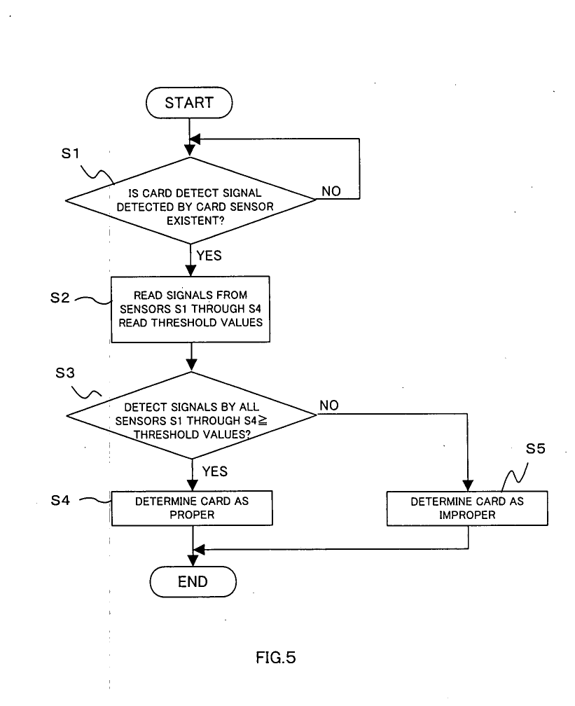

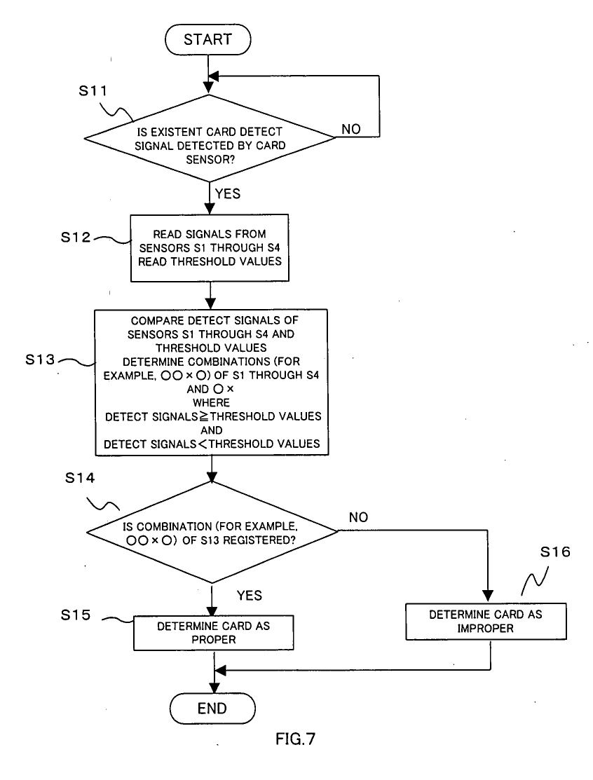

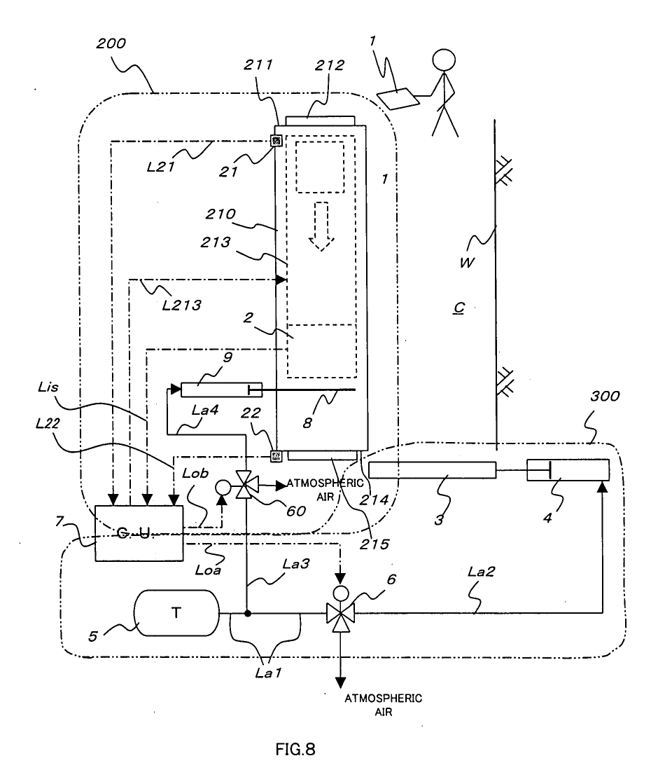

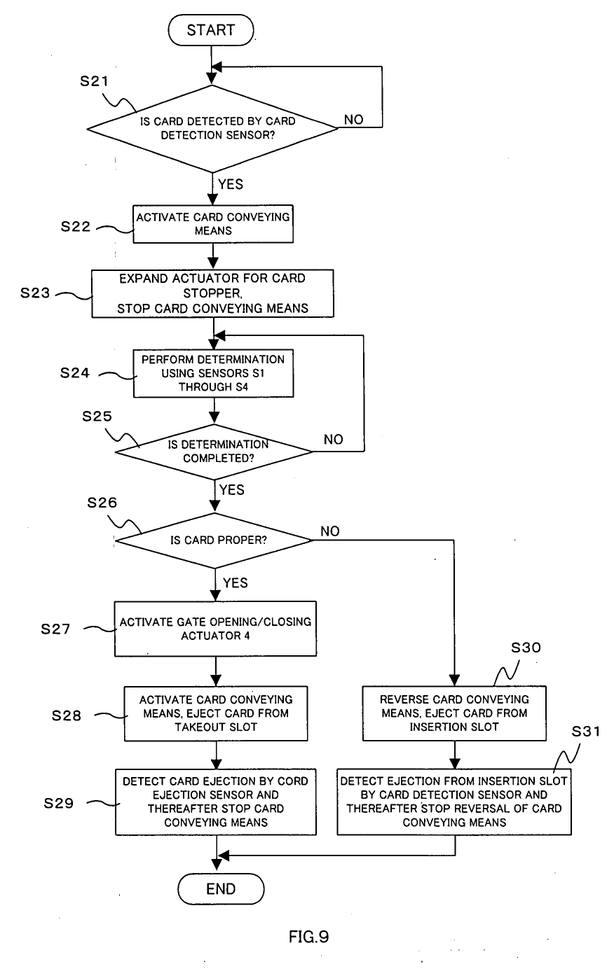

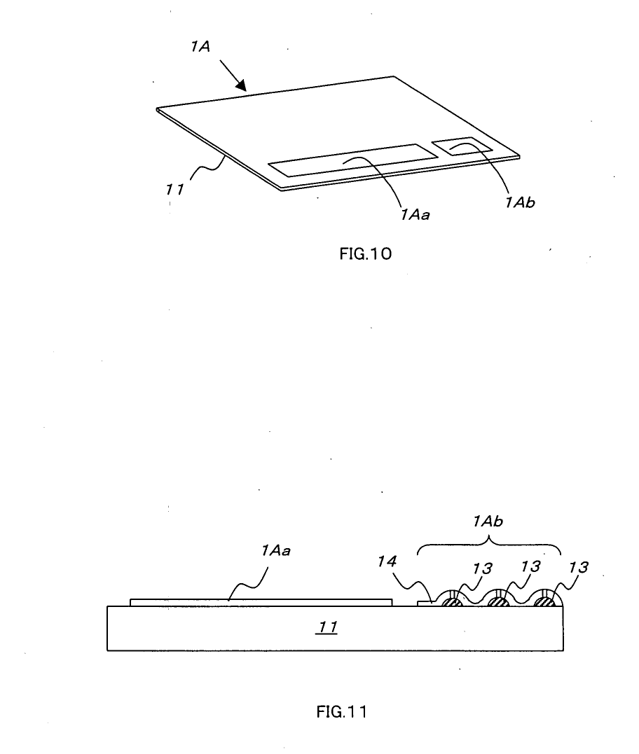

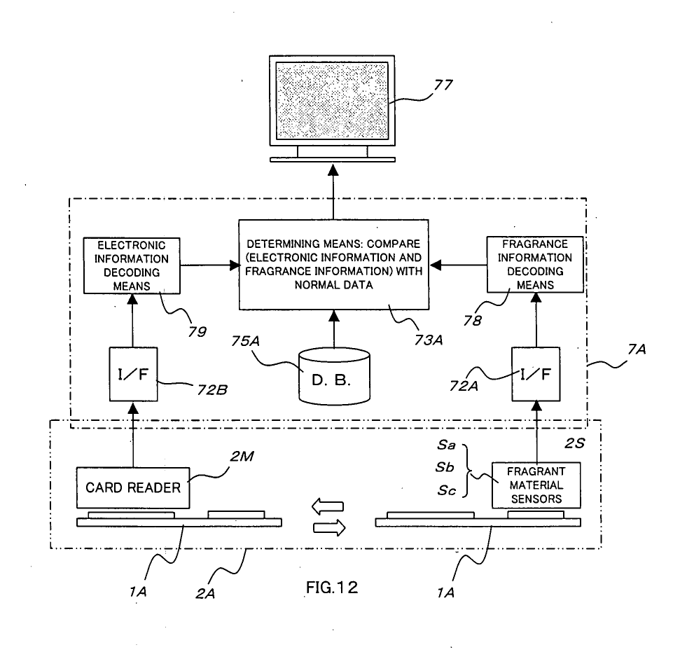

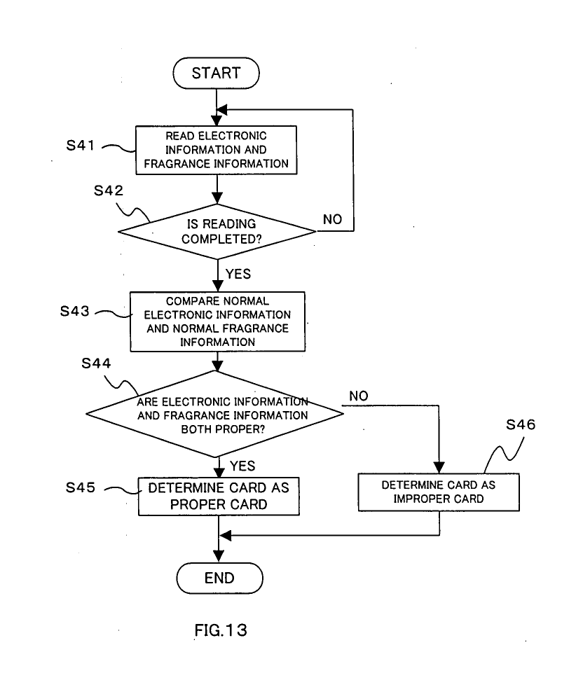

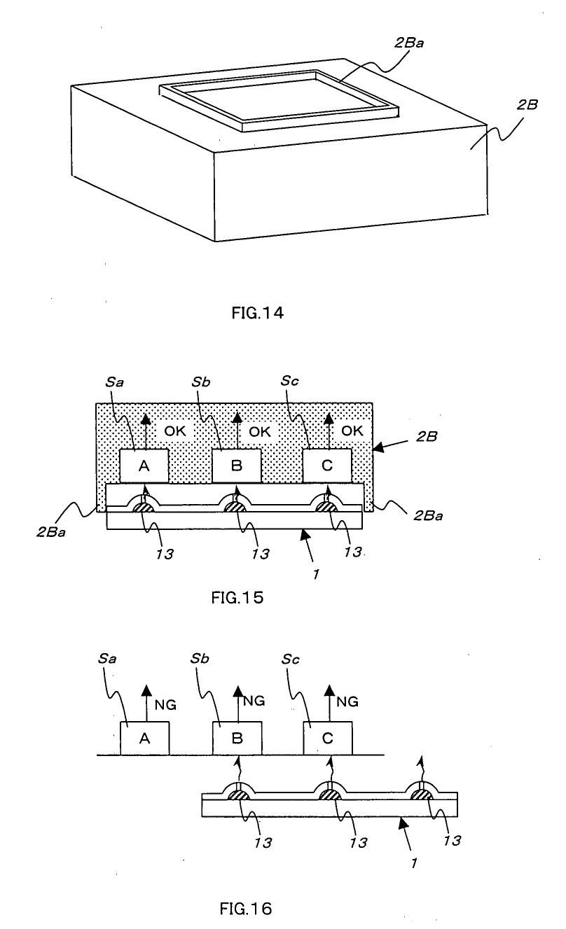

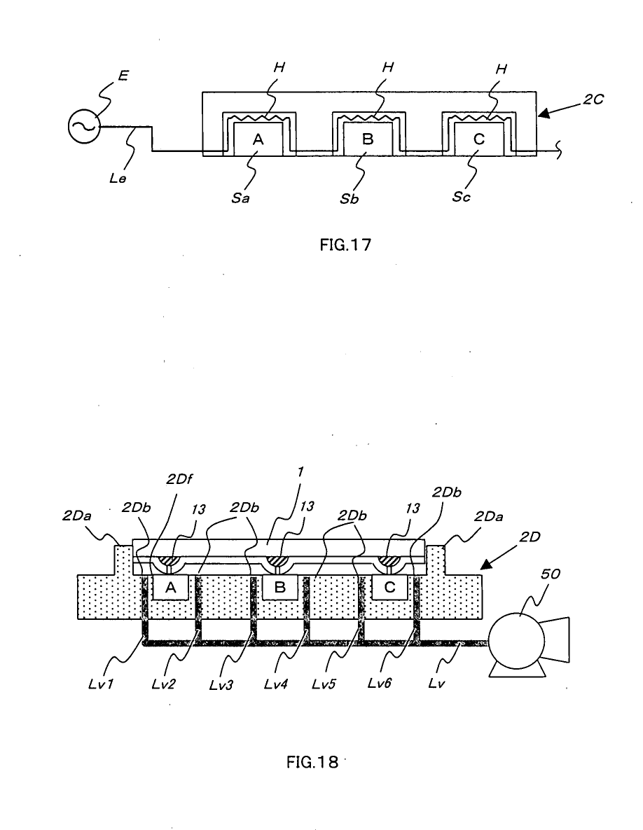

### EXPLANATION OF REFERENCE NUMERALS

1, 1A . . . cards
2, 2A, 2B, 2C, 2D . . . card readers
3 . . . gate
4 . . . gate opening/closing actuator
5 . . . pressure fluid source/air tank
6 . . . three-way valve
7 . . . control means
8 . . . card stopper
9 . . . actuator for card stopper
11 . . . substrate
13 . . . fragrant material chip
14 . . . film
15 . . .
21 . . . card detection sensor
22 . . . card ejection sensor
731 to 734 . . . comparing means
74 . . . authentication determining means

1. A card characterized in that fragrant materials are placed at predetermined locations on a surface thereof on the side of contact with a card reader, and the surface thereof on which the fragrant materials are placed in such a manner that a predetermined amount of fragrant-material molecules pass therethrough and are released, is covered so as to reach a flat surface.

2. The card according to claim 1, which stores therein information readable by electronic reading means.

3. A card reader for reading the information stored in the card according to claim 1, comprising:
sensors provided at positions corresponding to the fragrant materials placed on the card,
wherein the sensors are configured so as to output detect signals, responsive to only one type of fragrant material.

4. The card reader according to claim 3, further comprising electronic reading means configured so as to electronically read the information stored in the card other than the fragrant materials.

5. An authentication system comprising:
a card in which fragrant materials are placed at predetermined locations on a surface thereof, and the surface thereof on which the fragrant materials are placed in such a manner that a predetermined amount of fragrant-material molecules pass therethrough and are released, is covered so as to become a flat surface;
a card reader for reading the card, said card reader being configured in such a manner that sensors are provided at positions corresponding to the fragrant materials placed on the card and output detect signals, responsive to only one type of fragrant material; and
control means which determines whether the card brought into contact with the card reader is a proper card, in response to the detect signals sent from the sensors of the card reader.

6. An authentication system comprising:
a card in which fragrant materials are placed at predetermined locations on a surface thereof, and the surface thereof on which the fragrant materials are placed in such a manner that a predetermined amount of fragrant-material molecules pass therethrough and are released, is covered so as to become a flat surface, said card storing therein information readable by electronic reading means;
a card reader for reading the card, said card reader being configured in such a manner that sensors are provided at positions corresponding to the fragrant materials placed on the card and output detect signals, responsive to only one type of fragrant material, and being equipped with electronic reading means configured so as to electronically read the information stored in the card other than the fragrant materials; and
control means which determines whether the card brought into contact with the card reader is a proper card, in response to the detect signals sent from the sensors of the card reader and a read signal sent from the electronic reading means.
